(19) United States
(12) Patent Application Publication
(10) Pub. No.: US 2022/0212210 A1
(43) Pub. Date: Jul. 7, 2022

(54) METHOD AND DEVICES FOR COATING

(71) Applicant: Covestro (Netherlands) B.V., Nieuwegein (NL)

(72) Inventors: Richard Feller, Geleen (NL); Julien Gaury, Nieuwegein (NL); Kay Marie Allan Biesmans, Nieuwegein (NL); Hugo Schoot, Geleen (NL)

(21) Appl. No.: 17/600,641

(22) PCT Filed: Mar. 24, 2020
(86) PCT No.: PCT/EP2020/058102

§ 371 Date: Oct. 1, 2021

Related U.S. Application Data
(60) Provisional application No. 62/829,964, filed on Apr. 5, 2019.

(51) Int. Cl. B05B 1/20; B05D 1/02; B05B 13/00; F24S 40/00

(52) U.S. Cl. CPC B05B 1/20; F24S 40/00; B05B 13/005; B05D 1/02

(57) ABSTRACT

Disclosed are apparatuses and methods of coating glass structures installed in the field, such as installed solar panels or greenhouse roof panels. In an embodiment, an applicator for applying a coating to a glass structure comprising a plurality of glass panels, comprises an arm for supporting a spraying unit and comprising an interface for a connection to a vehicle, and a spraying unit connected to the arm and comprising a plurality of nozzles for spraying a coating onto a surface of a glass panel, wherein the spraying unit is configured to spray a coating on at least substantially the entire width of a plurality of glass panels

### FIELD OF THE INVENTION

The present inventions pertain to apparatuses and methods of coating glass structures installed in the field, such as installed solar panels or greenhouse roof panels.

### BACKGROUND

Often times a performance coating is applied to glass panels to improve a desired performance characteristic of the glass. For example, anti-reflective and/or anti-soiling coatings may be applied to the light-receiving surface of a solar panel cover glass or greenhouse roof panels.

With the advancement of coating technologies, many new installations of glass structures, such as solar farms or greenhouses, utilize glass panels having a performance coating already installed on the light-receiving surface of the glass from the factory. For such installations there is no need to coat the glass panels after installation, excepting the repair of damaged coatings.

However, there exist a large number of glass structures installed prior to the ubiquity of such factory-installed performance coatings. It is desired to coat these uncoated structures with a performance coating in order to improve their performance in the desired application.

One method of coating such structures is the use of a robot that coats the glass panel while the robot traverses the glass structure. The robots typically move via treads or a conveyor system.

Another example of a coating mechanism is disclosed in WO2015/177645. This mechanism utilizes a performance enhancement coating applicator head disposed on a mobile support structure. The mechanism may comprise a porous layer to transfer said performance enhancement coating on to a substrate.

### SUMMARY

Despite the above background, there is a need in the art for improved methods and devices for coating solar panels in the field. The use of robots has the disadvantage that the robot must be moved from one glass structure to another, such as multiple rows of solar panels. Such robots may also be very heavy and the movement therefore very cumbersome. Additionally, the robot must be fitted for the size of a specific structure, increasing costs and limiting flexibility when it is desired to coat various different sizes or shapes of structures.

Other coating methods, such as disclosed in WO2015/177645, may require continual priming and depleting of a coating application device, thereby increasing the time of the coating operation and affecting the uniformity of the coating.

Furthermore, existing coating systems may exhibit deficiencies in onset and offset coating uniformity. For example, existing coating systems must start the coating process already positioned on the glass structure and must stop at the other end of the glass structure.

The above-noted deficiencies may be at least partially overcome by the inventions disclosed herein.

In an embodiment, an applicator for applying a coating to a glass structure comprising a plurality of glass panels, comprises:
a. an arm for supporting a spraying unit and comprising an interface for a connection to a vehicle, and
b. a spraying unit connected to the arm and comprising a plurality of nozzles for spraying a coating onto a surface of a glass panel, wherein the spraying unit is configured to spray a coating on at least substantially the entire width of a plurality of glass panels.

The inventions disclosed herein may exhibit advantages in coating uniformity, coating integrity, ease of use, throughput, flexibility in design or size of glass structures coated, onset and offset coating uniformity, reduction in manual labor, cost, and other efficiencies.

### BRIEF DESCRIPTION OF THE DRAWINGS

FIG. 1 is a schematic of a glass structure.

FIG. 2 is a schematic of an embodiment of the invention in operation at a solar park.

FIG. 3 is a depiction of an embodiment of an applicator comprising a follower and a suspension system.

FIG. 4 is a cross-sectional view of an embodiment of an applicator comprising a wind cover.

### DESCRIPTION

In an embodiment, an applicator for applying a coating to a glass structure comprising a plurality of glass panels, comprises:
a. an arm for supporting a spraying unit and comprising an interface for a connection to a vehicle, and
b. a spraying unit connected to the arm and comprising a plurality of nozzles for spraying a coating onto a surface of a glass panel, wherein the spraying unit is configured to spray a coating on substantially the entire width of a plurality of glass panels.

In operation, the applicator sprays the coating onto the surface of the glass panel while the vehicle is driven alongside the glass panels on the ground below. This method has numerous advantages over the methods in the prior art. For example, spraying may begin prior to the spray of coating coming into contact with the first glass panel in a glass structure, thereby eliminating coating inconsistency at the onset position that may be present in applicators that are not able to traverse beyond the edge of the coating. Similar advantages may be exhibited in coating consistency at the onset position. Furthermore, the cumbersome movement of a coating applicator from one glass structure to another is mostly eliminated. Instead, the vehicle is merely driven from one glass structure to the next.

The coating is typically a liquid of low viscosity. A coating typically comprises a solvent and a quantity of solids and is sprayable through one or more nozzles. The coating may dry or cure to become a dried coating by various means, for example, evaporation or solvent, heat curing, or light-initiated curing.

A glass structure is a collection of immediately adjacent glass panels that exist in approximately the same plane along the width of the glass structure. For example, a glass structure may be one side of a triangular roof of a greenhouse or one string of solar panels in a solar park. The glass panels of a glass structure may be out of plane in the lengthwise direction, for example as results from uneven ground. A glass structure comprising a plurality of glass panels has both a length and a width. The length is the dimension along the light-receiving surface of the glass panels in the general direction in which the vehicle is driven. The width is the dimension along the light-receiving surface of the glass panels that is perpendicular to the length of the glass structure.

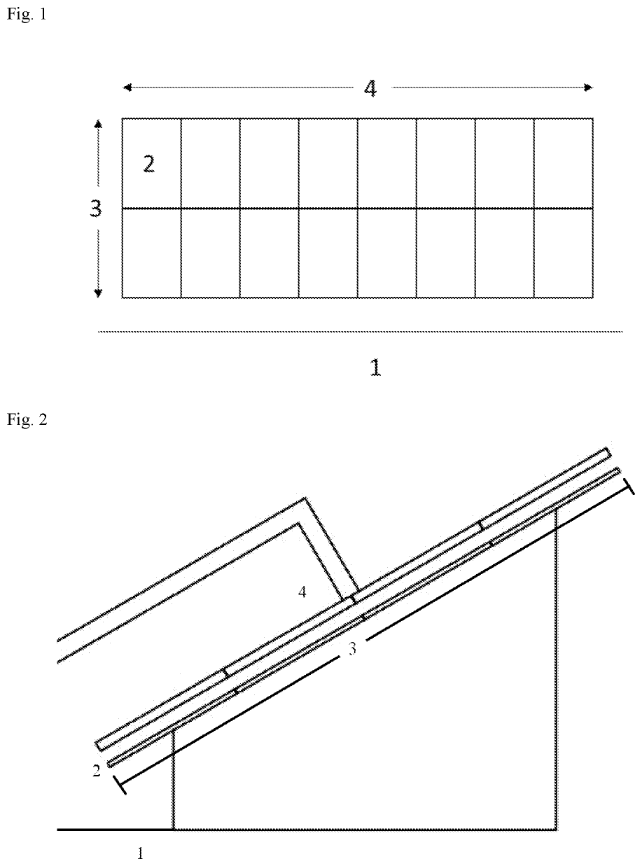

An example of a glass structure is shown in FIG. 1. The glass structure is supported above the ground 1 (supports not pictured) and comprises a plurality of glass panels 2. The glass structure possesses a width 3 and a length 4. In an embodiment, the glass panel is a solar panel. In an embodiment, the glass panel is the front cover glass of a solar panel. In an embodiment, the glass panel is a roof panel of a greenhouse. In an embodiment, the glass panel is a glass panel on the facade of a building. In an embodiment, the surface is the light-receiving surface of the glass panel.

The spraying unit may be configured to spray a coating on substantially the entire width of a plurality of glass panels. In this way a single pass coats at least substantially the entire width, such as the entire width, of the plurality of glass panels in a single pass as the vehicle is driven along the length of the glass structure. In one embodiment the applicator is configured to coat a plurality of adjacent glass panels in a single pass along the length of the plurality of adjacent glass panels. In an embodiment, the spraying unit may be of a certain length and the nozzles may be individually opened and closed based on operator control, thereby customizing the size of the spray to the width of the glass structure. In an embodiment, the spraying unit is modular, allowing for the installation and removal of additional section of spraying unit in order to customize the length of the spraying unit. In an embodiment, the applicator is configured to coat a stack of from two to five glass panels in width. In an embodiment, the applicator is configured to coat a stack of at most ten glass panels in width, for example at most eight glass panels in width. In an embodiment, the applicator is configured to coat a stack of at least eight glass panels in length, for example at least twelve glass panels in length.

Turning now to FIG. 2, a glass structure 2 is shown supported above the ground 1. The glass structure is four glass panels in width 3. The applicator 4 is configured to coat substantially the entire width of the glass panels.

The applicator comprises an arm for supporting the spraying unit and comprises an interface for connection to a vehicle. In an embodiment, the vehicle is a tractor, an excavator, or a boom lift. In an embodiment, the arm is configured to connect to a counter interface present on a vehicle. The vehicle may require installation of a complimentary interface before the interface of the arm may be connected to the vehicle. In an embodiment, the arm is configured to detachably connect to a vehicle.

In an embodiment the arm is movable in response to operator input, for example, a joystick or control panel present in the cabin of the vehicle. In an embodiment, the arm may be raised or lowered in response to operator input. In an embodiment, the arm further comprises a powered assist configured to raise and lower the arm in response to operator input. In an embodiment, the arm is movable by a hydraulics.

In an embodiment, the arm comprises more than one segment. In an embodiment, the arm comprises a hinge at a location along its length between the connection to the spraying unit and the interface.

The applicator comprises a spraying unit connected to the arm. The spraying unit comprises a plurality of nozzles. In an embodiment, the plurality of nozzles is configured for spraying a coating onto the light-receiving surface of the glass panel. The nozzles can possess any desired orientation suitable for spraying a coating onto the light-receiving side of a glass panel, such as a 45-degree orientation. Flow of coating through the nozzles may be monitored and/or controlled by the operator via a control panel positionable in a vehicle. In an embodiment, the nozzles are individually controllable. In an embodiment, the nozzles are individually controllable via a control panel positionable in a vehicle. In an embodiment, the applicator further comprises a control panel configured to control the passage of coating through the nozzles in response to operator input.

In an embodiment, the spraying unit comprises from 5 to 100 nozzles, such as from 5, 10, 15, 20, or 25 nozzles, to 100, 90, 80, 70, 60, 50, or 40 nozzles. In an embodiment, the applicator is configured such that the nominal height of the nozzles from the light-receiving surface of a glass panel is from 5 to 30 cm.

The coating supply may be located remotely from the spraying unit, such as on the vehicle, on a trailer connected to the vehicle, or on a vehicle that is different than the vehicle to which the applicator is attached. In an embodiment, the spraying unit is connected to a container for holding a quantity of coating. In an embodiment, the spraying unit is connected to a container for holding a quantity of coating configured to be stored on a vehicle.

Depending on the type of coating, it may be desirable to flush the nozzles with a rinsing agent, such as a solvent, at the conclusion of coating application so that the nozzle does not become clogged with dried coating. In an embodiment, the spraying unit is connected to a container for holding a quantity of coating and connected to a container for holding a quantity of rinsing agent, wherein the applicator further comprises a valve for controlling whether the nozzles dispense coating or rinsing agent. Control for the valve(s) may be located on a control panel present in the vehicle.

In an embodiment, the applicator further comprises a suspension system connected to the arm, the suspension system configured to control the distance between the nozzles and a surface of a glass panel. The suspension system need not be the sole control of the distance between the nozzles and a surface of a glass panel. In an embodiment, the suspension system comprises a damper configured to reduce variations in the distance between the glass panel and the spraying unit.

In an embodiment, the applicator further comprises a follower. In an embodiment the follower is connected to the spraying unit or the arm and configured to contact a surface of a glass pane. By follower it is not meant that the follower must trail the other parts of the applicator, but rather that the follower follows along a surface of the glass structure by contacting a surface of the glass structure.

In an embodiment, the suspension system reacts to the amount of force exerted on the surface of a glass panel by the follower. In an embodiment, the follower is configured to contact the surface of a glass panel in front of the spraying device. In an embodiment, the follower is configured to contact the light-receiving surface of a glass panel. In an embodiment, the follower comprises a wheel for contacting the surface of a glass panel. In an embodiment, the follower is connected to the spraying unit. The distance between the nozzles and the surface of a glass panel may accordingly be determined by the position of the follower connected to the spraying unit. In an embodiment, the suspension system is configured to attempt to keep the force exerted on the glass panel by the follower constant. In an embodiment, the suspension system is configured to control the distance between the nozzles and a surface of a glass panel by movement of the arm.

In an embodiment, the suspension system comprises a hydropneumatic suspension. For example, a hydropneumatic suspension comprises a pressure accumulator in cooperation with a hydraulic cylinder. The pressure accumulator typically comprises both a hydraulic fluid and a gas, such as air or nitrogen. In an embodiment, the pressure accumulator is connected to a hydraulic cylinder and, as a result of different pressurization, the hydraulic cylinder compensates for differences in forces experienced by the applicator so as to ensure the force exerted on the surface of the glass panel by the followers is kept mostly constant.

In an embodiment, the suspension system further comprises a pressure regulator for regulating the pressure of the hydraulic fluid and/or the gas. In this way the pressure in the pressure accumulator can be adjusted as needed based on the weight of the applicator and the desired distance between the nozzles and the surface of the glass panel and then held constant during the coating process.

In an embodiment, the suspension system comprises two hydraulic cylinders. A first hydraulic cylinder operates to ensure the force exerted on the surface of the glass panel by the followers is kept mostly constant. A second hydraulic cylinder is employed to raise and lower the arm into position on the surface of the glass panel. For example at the end of a row of solar panels in a solar park, hydruaulic fluid is applied to the second hydraulic cylinder, raising the arm and lifting the spraying unit away from the panels; at the start of the next row of panels, hydraulic fluid is removed from the second hydraulic cylinder, lowering the arm and causing the spraying unit to contact the surface of the glass panel. Pneumatic cylinders may be used instead of hydraulic cylinders.

In an embodiment, the applicator further comprises a cleaning unit. In an embodiment, a cleaning unit comprises a spraying system for the application of a cleaning fluid, for example water, or a cleaning gas, for example air. In an embodiment, a cleaning unit comprises at least one of a brush and a cloth for physically contacting the surface of the glass panel. A cleaning unit acts to remove dirt, dust, debris or other soiling from the surface of the glass panel prior to the application of a coating by the spraying unit. In an embodiment, a cleaning unit is attached to the front of the spraying unit. In an embodiment, a cleaning unit is attached to the arm in front of the spraying unit.

In an embodiment a stop is employed to control the position of the spraying unit, for example the angle of the spraying unit or the maximum extension of the spraying unit relative to the arm. In an embodiment the stop is adjustable. In an embodiment, the stop is hydraulic or pneumatic.

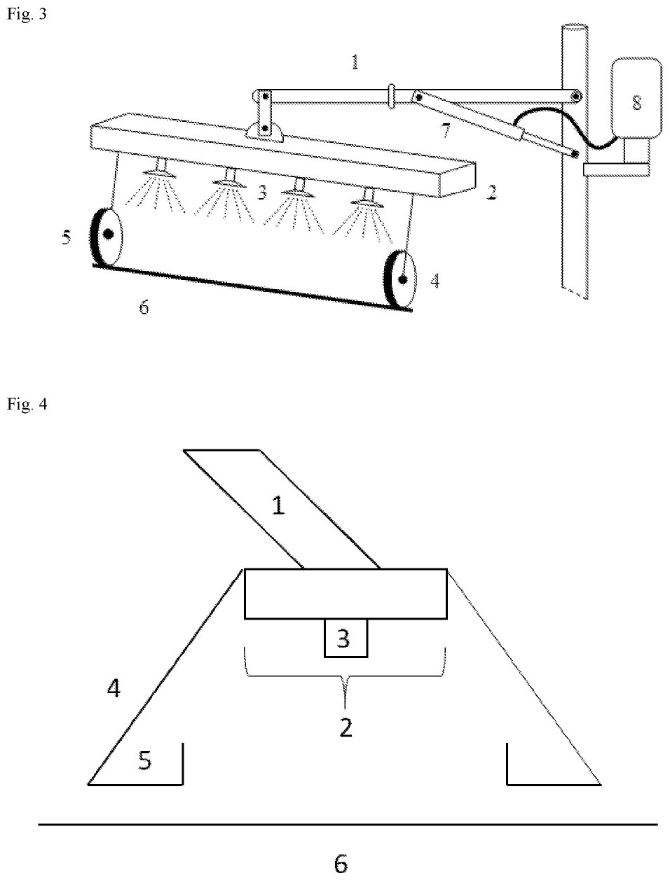

A depiction of an embodiment of an applicator is depicted in FIG. 3. The applicator comprises arm 1 which supports spraying unit 2 and may be connected to a vehicle (connection and vehicle not pictured). Spraying unit 2 comprises four nozzles 3 configured for spraying a coating onto substantially the entire width of the light-receiving surface of a glass panel 6. The applicator comprises two followers 4 and 5 connected to the spraying unit 2 and configured to contact the light-receiving surface of the glass panel 6. The applicator comprises a suspension system comprising hydraulic cylinder 7 and pressure accumulator 8. The hydraulic cylinder 7 is connected to the pressure accumulator 8 and, as a result of different pressurization in hydraulic cylinder 7 and pressure accumulator 8, the hydraulic cylinder 7 compensates for differences in forces experienced by the applicator so as to ensure the force exerted by the followers 4, 5 on the light-receiving surface of the glass panel 6 is kept mostly constant.

In an embodiment, the applicator further comprises a wind cover. The wind cover is over the nozzles. In an embodiment, the wind cover angles away from the nozzles as the wind cover extends toward the location of the glass panel. In an embodiment, the wind cover comprises a gutter for collecting coating that may come into contact with the interior of the wind cover during spraying. In an embodiment, the gutter is connected to a container for collecting such coating. For example, the container may be in fluid communication with the gutter via a hole in the end of gutter that is most proximate the ground during operation of the applicator. As coating runs down the gutter due to gravity it may flow through the hole and be collected in the container.

A cross-section of an embodiment of an applicator comprising a wind cover is depicted in FIG. 4. The cross-sectional view depicts an arm 1 and a spraying unit 2. The spraying unit comprises a plurality of nozzles, of which a single nozzle 3 is depicted in the cross-sectional view. The wind cover 4 is positioned over spraying unit 2 and comprises gutter 5. As depicted, both sides of the wind cover comprise a gutter. The wind cover 4 angles away from the nozzles as the wind cover extends toward the location of glass panel 6. A follower and suspension system may also be present but are not pictured in FIG. 4.

The present invention further provides a method of coating a glass structure comprising the steps of:
a. spraying a coating onto substantially the entire width of a glass structure via an applicator positioned at a desired height above the glass structure, wherein the applicator comprises a plurality of nozzles,
b. traversing the glass structure length-wise by driving a vehicle to which the applicator is attached over ground proximate the glass structure while spraying the coating, and
c. controlling the height of the applicator above the glass structure such that the height of the applicator above the glass structure is substantially uniform despite variations in height of the glass structure and the ground.

In an embodiment, the step of controlling the height of the applicator is carried out by controlling that the force exerted by the applicator on the glass structure is substantially uniform. An embodiment further comprises the step of cleaning the nozzles with rinsing agent. An embodiment further comprises the step of shielding the nozzles from wind via a wind cover positioned over the plurality of nozzles. An embodiment further comprises the steps of shielding the nozzles from wind via a wind cover positioned over the plurality of nozzles and collecting coating that contacts the interior of the wind cover. In an embodiment the applicator is the applicator as described above.

The present invention further provides a solar panel comprising a coating formed according to the method as described above.

The present invention further provides an array of solar panels comprising a coating formed according to the method as described above.

The present invention further provides a building comprising windows, the windows comprising a coating formed according to the method as described above.

The present invention further provides a vehicle comprising the applicator as described above.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. While certain optional features are described as embodiments of the invention, the description is meant to encompass and specifically disclose all combinations of these embodiments unless specifically indicated otherwise or physically impossible.

1. An applicator for applying a coating to a glass structure comprising a plurality of glass panels, comprising:
a. an arm for supporting a spraying unit and comprising an interface for a connection to a vehicle, and
b. a spraying unit connected to the arm and comprising a plurality of nozzles for spraying a coating onto a surface of a glass panel, wherein the spraying unit is configured to spray a coating on at least substantially the entire width of a plurality of glass panels, wherein the surface is optionally a light-receiving surface.

2. The applicator according to claim 1, further comprising a suspension system connected to the arm, the suspension system is configured to control the distance between the nozzles and the surface of a glass panel, optionally by movement of the arm, and wherein the suspension system optionally comprises a hydropneumatic suspension.

3. (canceled)

4. The applicator according to claim 1, further comprising a follower connected to the spraying unit or the arm and configured to contact a surface of a glass panel, wherein the follower is optionally configured to contact the surface of the glass panel in front of the spraying device, wherein the surface is optionally a light-receiving surface, and wherein the follower optionally comprises a wheel for contacting the surface of the glass panel.

5. The applicator according to claim 3, wherein a suspension system connected to the arm reacts to the amount of force exerted on the surface of a glass panel by the follower and/or wherein the suspension system is configured to attempt to keep the force exerted on the glass panel by the follower constant.

6. (canceled)

7. (canceled)

8. (canceled)

9. The applicator according to claim 1, further comprising a wind cover over the nozzles, wherein the wind cover comprises a gutter for collecting coating that may come into contact with the interior of the wind cover during spraying and the gutter is connected to a container for collecting such coating.

10. The applicator according to claim 1, wherein the arm is configured to detachably connect to a vehicle, optionally via a counter interface present on the vehicle, and wherein the arm optionally comprises a hinge between the spraying unit and the interface.

11. (canceled)

12. (canceled)

13. The applicator according to claim 1, wherein the arm may be raised or lowered in response to operator input, optionally wherein the arm comprises a powered assist configured to raise and lower the arm in response to operator input.

14. (canceled)

15. The applicator according to claim 1, further comprising a control panel configured to control the passage of coating through the nozzles in response to operator input.

16. The applicator according to claim 1, wherein the spraying unit comprises from 5 to 100 nozzles.

17. (canceled)

18. The applicator according to claim 1, wherein the plurality of nozzles are individually controllable and/or wherein the spraying unit is modular, thereby allowing for the installation and removal of sections of the spraying unit in order to customize the length of the spraying unit.

19. (canceled)

20. The applicator according to claim 1, wherein the applicator is configured such that the nominal height of the nozzles from the surface of the glass panel is from 5 to 30 cm.

21. The applicator according to claim 1, wherein the spraying unit is connected to a container for holding a quantity of coating, optionally wherein the quantity of coating is further configured to be stored on a vehicle.

22. (canceled)

23. The applicator according to claim 1, wherein the spraying unit is connected to a container for holding a quantity of coating and connected to a container for holding a quantity of rinsing agent, wherein the applicator further comprises a valve for controlling whether the nozzles dispense coating or rinsing agent.

24. (canceled)

25. (canceled)

26. (canceled)

27. (canceled)

28. (canceled)

29. (canceled)

30. The applicator according to claim 1, wherein the applicator is configured to coat a plurality of adjacent glass panels in a single pass along the length of the plurality of adjacent glass panels, optionally wherein the applicator is configured to coat a stack of from two to five glass panels in width, and optionally wherein the applicator is configured to coat a stack of at least eight glass panels in length.

31. (canceled)

32. (canceled)

33. The applicator according to claim 1, wherein the glass panel is a solar panel, the front cover glass of a solar panel, a roof panel of a greenhouse, or a glass panel on the facade of a building.

34. (canceled)

35. (canceled)

36. (canceled)

37. (canceled)

38. A method of coating a glass structure comprising the steps of:
a. spraying a coating onto substantially the entire width of a glass structure via an applicator positioned at a desired height above the glass structure, wherein the applicator comprises a plurality of nozzles, optionally wherein the applicator is the applicator of claim 1,
b. traversing the glass structure length-wise by driving a vehicle to which the applicator is attached over ground proximate the glass structure while spraying the coating, and
c. controlling the height of the applicator above the glass structure such that the height of the applicator above the glass structure is substantially uniform despite variations in height of the glass structure and the ground.

39. The method according to claim 16, wherein the step of controlling the height of the applicator is carried out by controlling that the force exerted by the applicator on the glass structure is substantially uniform.

40. The method according to claim 16, further comprising the step of cleaning the nozzles with rinsing agent.

41. The method according to claim 16, further comprising the step of shielding the nozzles from wind via a wind cover positioned over the plurality of nozzles and optionally collecting coating that contacts the interior of the wind cover.

42. (canceled)

43. (canceled)

44. A solar panel, an array of solar panels, or a window, comprising a coating formed according to the method of claim 16.

45. (canceled)

46. (canceled)

47. A vehicle comprising the applicator according to claim 1 attached to the vehicle.
